(19) United States
(12) Patent Application Publication
(10) Pub. No.: US 2025/0085130 A1
(43) Pub. Date: Mar. 13, 2025

(54) CONTINUE MAPS CONTEXT BETWEEN MOBILE AND CAR INFOTAINMENT SYSTEM

(71) Applicant: QUALCOMM Incorporated, San Diego, CA (US)

(72) Inventors: Sai Kousik SWARNA, Hyderabad (IN); Gohulan BALACHANDRAN, Puyallup, WA (US); Srikanth CHINTALA, Hyderabad (IN); Sankar GONELLA, Hyderabad (IN); Garik BADALYAN, San Diego, CA (US)

(21) Appl. No.: 18/466,749

(22) Filed: Sep. 13, 2023

(51) Int. Cl. G01C 21/36; H04W 4/06; H04W 4/40

(52) U.S. Cl. CPC G01C 21/362; G01C 21/3667; H04W 4/06; H04W 4/40

(57) ABSTRACT

Aspects presented herein may enable a UE to transmit/broadcast navigation information associated with a navigation session to an on-board unit (OBU) (e.g., an infotainment system of a vehicle) to enable the OBU to resume/continue the navigation session. In one aspect, a UE establishes communication with an OBU, where the communication is based on a data sharing protocol. The UE transmits, to the OBU, route information based on the established communication, where the route information is associated with at least one destination. The UE receives, from the OBU, a confirmation of the route information.

### TECHNICAL FIELD

The present disclosure relates generally to communication systems, and more particularly, to a wireless communication involving navigation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus establishes communication with an on-board unit (OBU), where the communication is based on a data sharing protocol. The apparatus transmits, to the OBU, route information based on the established communication, where the route information is associated with at least one destination. The apparatus receives, from the OBU, a confirmation of the route information.

In an aspect of the disclosure, a method, a computer-readable medium, and an apparatus are provided. The apparatus establishes first communication with a first user equipment (UE), where the communication is based on a data sharing protocol. The apparatus receives, from the first UE, first route information based on the established first communication, where the first route information is associated with at least one first destination. The apparatus outputs a navigation route for the at least one first destination.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a navigation application in accordance with various aspects of the present disclosure.

FIG. 6 is a diagram illustrating an example navigation scenario in accordance with various aspects of the present disclosure.

FIG. 7 is a diagram illustrating an example navigation scenario involving multiple users in accordance with various aspects of the present disclosure.

FIG. 8 is a diagram illustrating an example of a context sharing framework in accordance with various aspects of the present disclosure.

FIG. 9 is a diagram illustrating an example of a context sharing framework message format in accordance with various aspects of the present disclosure.

FIG. 10 is a diagram illustrating an example of using a context sharing framework to continue an ongoing navigation/map session in one device on another device in accordance with various aspects of the present disclosure.

FIG. 11 is a diagram illustrating an example of using a context sharing framework to continue ongoing navigation/map sessions in multipole devices on another device in accordance with various aspects of the present disclosure.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a diagram illustrating an example of a hardware implementation for an example apparatus and/or network entity.

### DETAILED DESCRIPTION

Aspects presented herein may improve the efficiency of navigation by enabling a navigation system/application to be paired with one or more user equipments (UEs) (e.g., mobile phones, smart watches, etc.) and to resume/continue navigation session(s) performed by the one or more UEs via the navigation system/application automatically. Aspects presented herein may enable automatic detection of devices and sharing contexts (e.g., data, information, etc.) between devices based on using a context sharing framework (which may also be referred to as a data sharing protocol), such as using a distributed context fabriq (DCF) framework, where such context sharing framework may enable devices to be configured to perform/act intelligently without much user input(s). For example, a seamless navigation and transition experience may be provided between a mobile device and a car infotainment system, which may reduce distractions to drivers during driving.

Aspects presented herein are directed to techniques/protocols for enhancing map context exchange/sharing between UEs and car infotainment system. Aspects presented herein include following aspects based on DCF (distributed context fabriq) feature/protocol: 1) Scenario 1: where a user has an ongoing maps session in mobile/wearable device: DCF-based discovery and context sharing between a mobile device and car infotainment system to manage maps/navigation system based on map context information (e.g., location coordinates of destination) provided by the mobile device to the infotainment system using DCF. 2) Multiple people are travelling in same vehicle: DCF-based discovery and context sharing between multiple devices in the car and the infotainment system to manage maps/navigation systems including conflict resolution when multiple people want to set different destinations in maps/navigation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

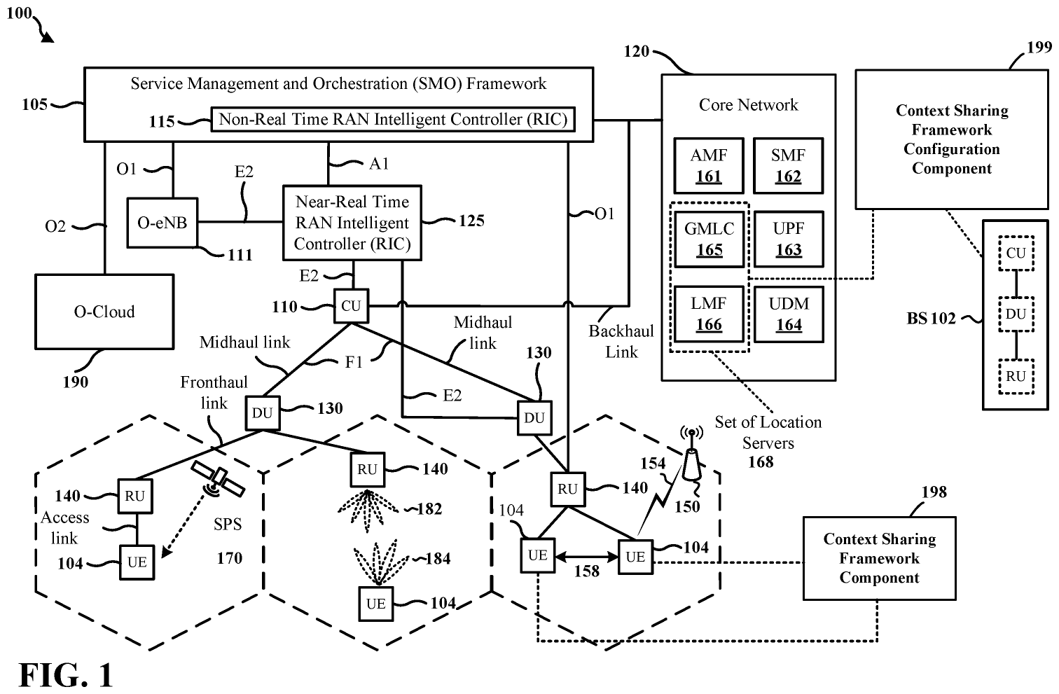

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a context sharing framework component 198 that may be configured to establish communication with an OBU, where the communication is based on a data sharing protocol; and transmit, to the OBU, route information based on the established communication, where the route information is associated with at least one destination; and receive, from the OBU, a confirmation of the route information. In certain aspects, the context sharing framework component 198 may be configured to establish first communication with a first UE, where the first communication is based on a data sharing protocol; receive, from the first UE, first route information based on the established first communication, where the first route information is associated with at least one first destination; and output a navigation route for the at least one first destination. In certain aspects, the base station 102 or the one or more location servers 168 may have a context sharing framework configuration component 199 that may be configured to provide context sharing framework configuration(s) to the UE 104.

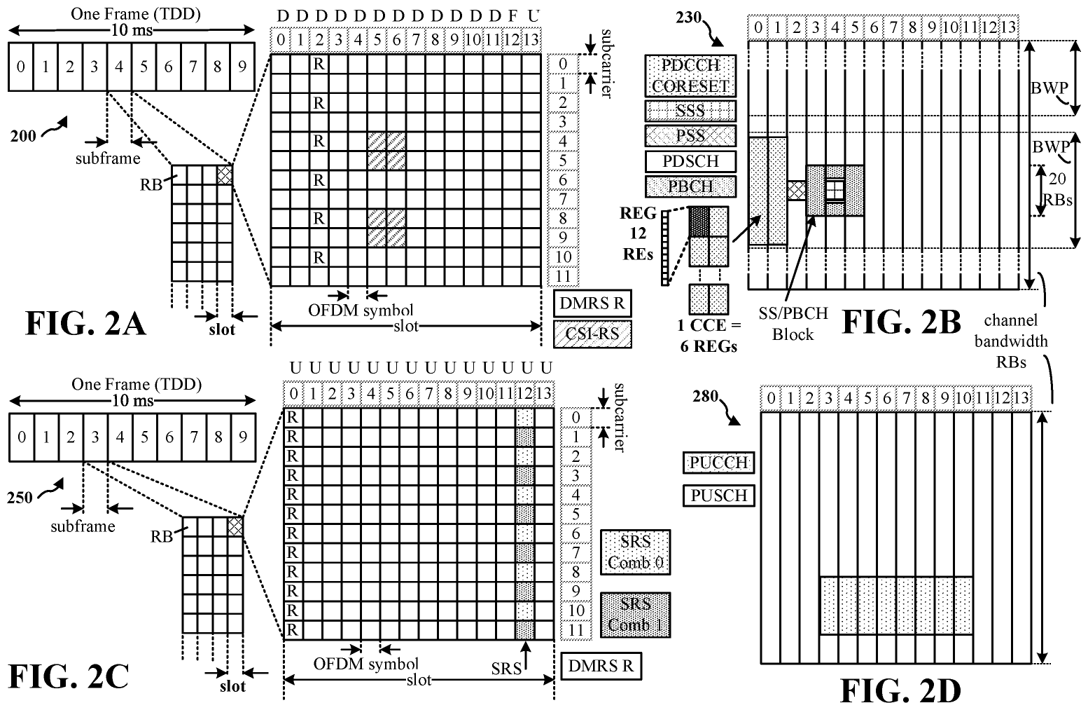

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [KHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ} *15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

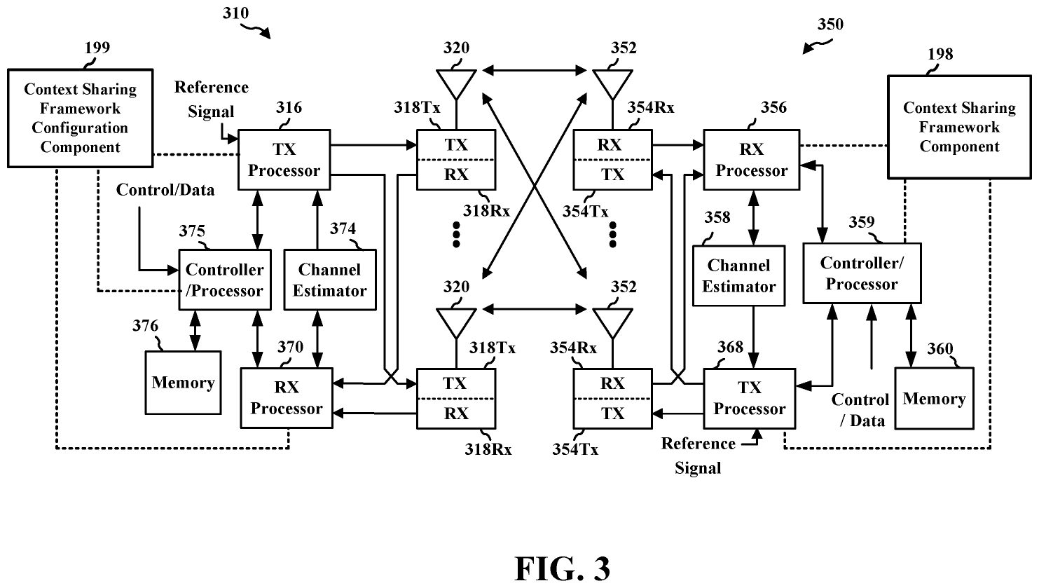

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the context sharing framework component 198 of FIG. 1.

At least one of the TX processor 316, the RX processor 370, and the controller/processor 375 may be configured to perform aspects in connection with the context sharing framework configuration component 199 of FIG. 1.

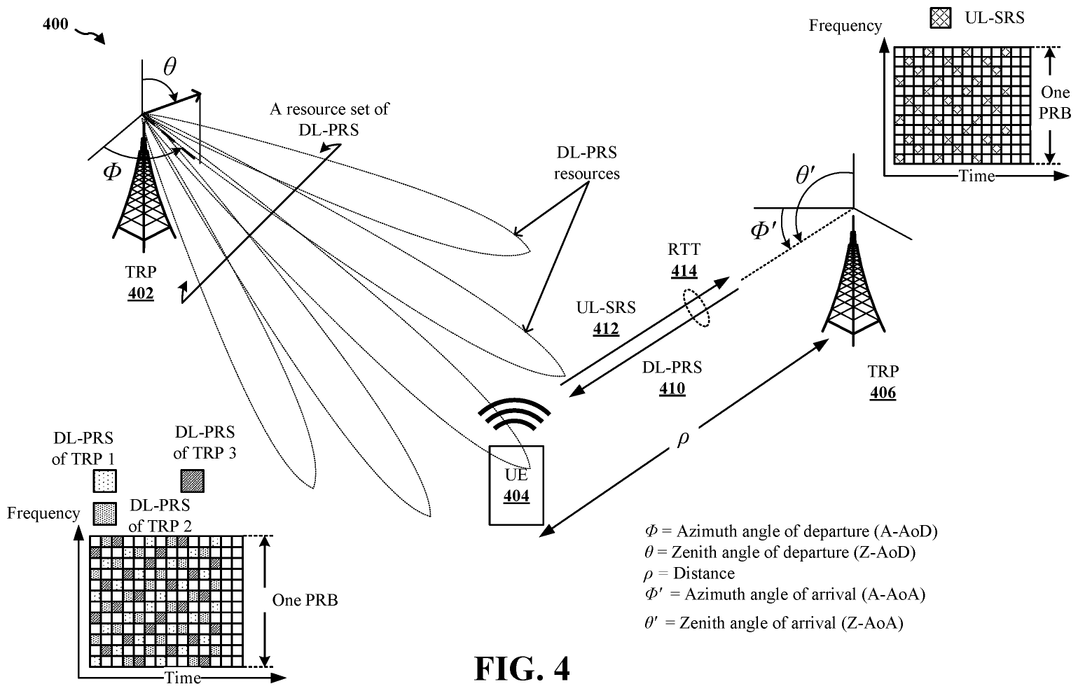

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|-|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR. TRS, PTRS, CRS, CSI-RS, DMRS, PSS, SSS. SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

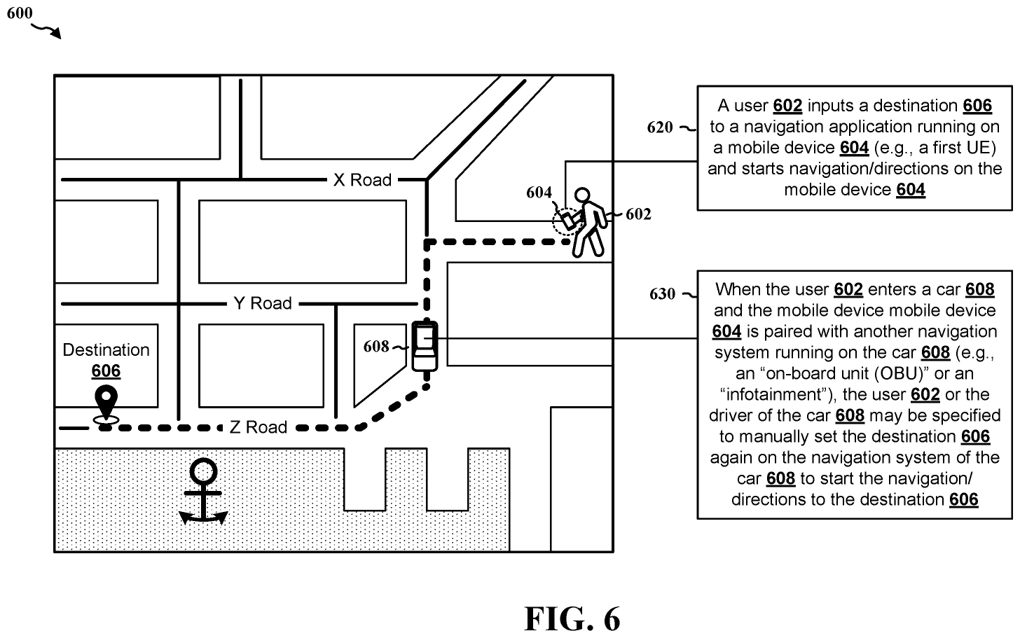

In some examples, a software or an application that accepts positioning related measurements from global navigation satellite system (GNSS)/global positioning system (GPS) chipset(s), sensor(s), and/or camera(s) to estimate the position, the velocity, and/or the altitude of a device (or a target) may be referred to as a positioning engine (PE). A positioning engine that is capable of achieving certain high level of accuracy (e.g., a centimeter/decimeter level accuracy) and/or latency may be referred to as a precise positioning engine (PPE). For example, a positioning engine that is capable of performing real-time kinematic positioning (RTK) (e.g., receiving or processing correction data associated with RTK as described in connection with FIG. 6) may be considered as a PPE. Another example of PPE is a positioning engine that is capable of performing precise point positioning (PPP). PPP is a positioning technique that removes or models GNSS/GPS system errors to provide a high level of position accuracy from a single receiver.

In some examples, a navigation application/software may refer to an application/software in a user equipment (e.g., a smartphone, a vehicle, an on-board unit (OBU) of a vehicle, an in-vehicle navigation system, a GNSS/GPS device, a car infotainment system, etc.) that is capable of providing navigational directions in real time. Over the last few years, users have increasingly relied on navigation applications because they have provided various benefits. For example, navigation applications may provide convenience to users as they enable users to find a way to their destinations, and also allow users to contribute information and mark places of importance thereby generating the most accurate description of a location. In some examples, navigation applications are also capable of providing expert guidance for users, where a navigation application may guide a user to a destination via the best, most direct, or most time-saving routes. For example, a navigation application may obtain the current status of traffic, and then locate a shortest and fastest way for a user to reach a destination, and also provide approximately how long it will take the user to reach the destination. As such, a navigation application may use an Internet connection, map data from a server, and/or a GPS/GNSS navigation system to provide turn-by-turn guided instructions on how to arrive at a given destination.

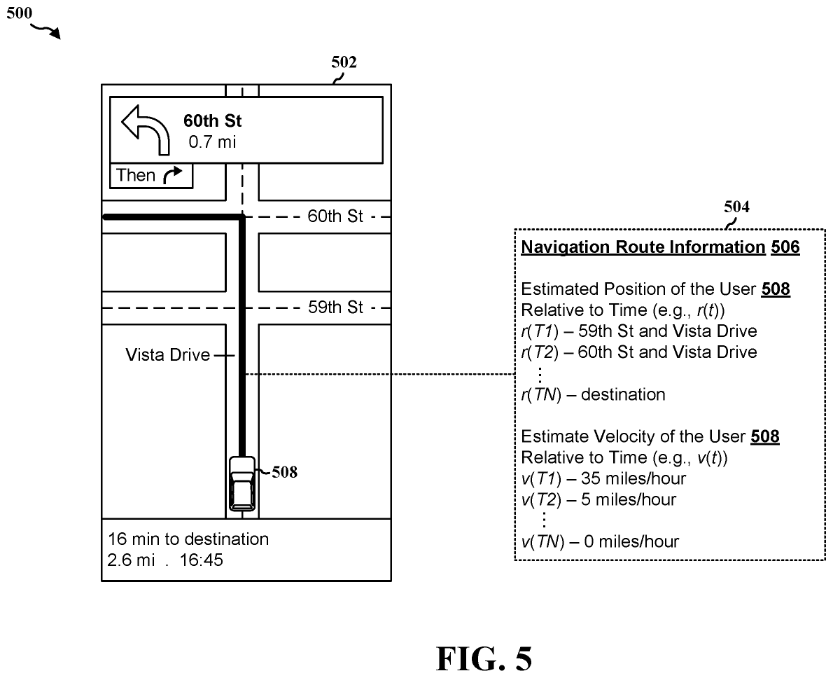

FIG. 5 is a diagram 500 illustrating an example of a navigation application in accordance with various aspects of the present disclosure. As shown at 502, a navigation application, which may be running on a UE such as a vehicle (e.g., a built-in GPS/GNSS system of the vehicle) or a smartphone, may provide a user (e.g., via a display or an interface) with turn-by-turn directions to a destination and an estimated time to reach the destination based on real-time information. For example, the navigation application may receive/download real-time traffic information, road condition information, local traffic rules (e.g., speed limits), and/or map information/data from a server. Then, the navigation application may calculate a route to the destination based on at least the map information and other available information. The map information may include the map of the area in which the user is traveling, such as the streets, buildings, and/or terrains of the area, or a map that is compatible with the navigation application and GPS/GNSS system. In some examples, the route calculated by the navigation application may be the shortest or the fastest route. For purposes of the present disclosure, information associated with this calculated route may be referred to as navigation route information. For example, navigation route information may include predicted/estimated positions, velocities, accelerations, directions, and/or altitudes of the user at different points in time.

For example, as shown at 504, based on the map information, the speed limit, and the real-time road condition information, the navigation application may generate navigation route information 506 that guides a user 508 to a destination. In some examples, the navigation route information 506 may include the position of the user and velocity of the user relative/respect to time, which may be denoted as \vec{r}(t) and \vec{v}(t), respectively. For example, the navigation application may estimate that at a first point in time (T1), the user may reach a first point/place with certain speed (e.g., the intersection of 59th Street and Vista Drive with a velocity of 35 miles per hour), and at a second point in time (T2), the user may reach a second point/place with certain speed (e.g., the intersection of 60th Street and Vista Drive with a velocity of 15 miles per hour), and up to N^{th} point in time (TN), etc.

FIG. 6 is a diagram 600 illustrating an example navigation scenario in accordance with various aspects of the present disclosure. In one example, as shown at 620, a user 602 seeking navigation assistance for reaching a destination 606 may input the destination 606 to a navigation application on a mobile device 604. Then, as discussed in connection with FIG. 5, the mobile device 604 may provide navigation route information (e.g., via a display) to the user 602, and the user 602 may travel towards the destination 606 based on (e.g., following) the displayed navigation route information on the mobile device 604.

As shown at 630, if the user 602 enters a car 608 and the mobile device 604 is paired with another navigation system running on the car 608, which may be referred to as an “on-board unit (OBU)” or an “infotainment” for purposes of disclosure and differentiation, the user 602 or another person (e.g., the driver) in the car 608 may be specified to manually set the destination 606 again on the navigation system of the car 608 to start the navigation/directions to the destination 606. For purposes of the present disclosure, the term “infotainment” may be a portmanteau of “information” and “entertainment,” which may refer to a media content that combines elements of both information and entertainment. A goal of an infotainment may be to provide informative content in an engaging and entertaining manner. Similarly, an infotainment system may be a device that includes both an information system (e.g., a navigation application, a car information display system, etc.) and an entertainment system (e.g., an audio/video system). Also, the term “car” and “vehicle” may be used interchangeably throughout the specification, which may refer to a transportation powered by an engine that is capable of carrying a small number of people (at least a driver).

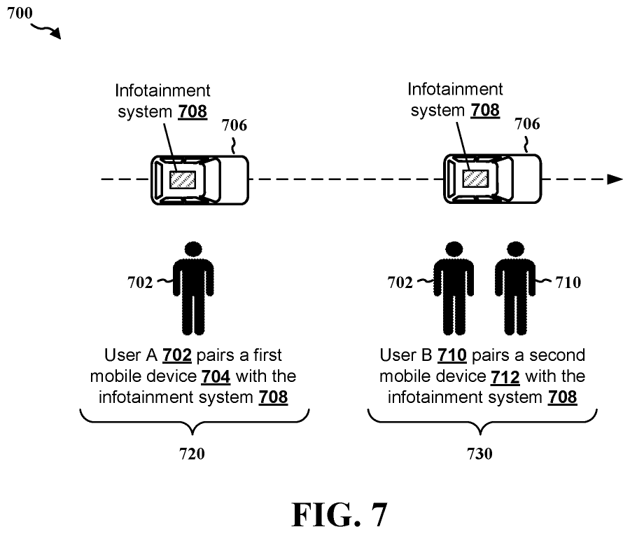

FIG. 7 is a diagram 700 illustrating an example navigation scenario involving multiple users in accordance with various aspects of the present disclosure. When a group of people are travelling in a car, multiple mobile devices may be able to pair with the infotainment system of the car. For example, as shown at 720, a first user 702 (User A) travelling in a car 706 may pair his/her mobile device (e.g., a first mobile device 704) with an infotainment system 708 of the car 706. Then, the first user 702 may be able to control or provide input to the infotainment system 708 based on the pairing, such as by providing a destination (e.g., the home of the first user 702) to (the navigation application/function of) the infotainment system 708, and enabling the infotainment system 708 to navigate/direct the driver of the car 706 to the destination provided by the first user 702. Similarly, as shown at 730, when a second user 710 (User B) is also in the car 706 or enters the car 706 after the first user 702, the second user 710 may also pair his/her mobile device (e.g., a second mobile device 712) with the infotainment system 708, provide a second destination (e.g., the home of the second user 710) to the infotainment system 708, and enable the infotainment system 708 to navigate/direct the driver of the car 706 to the second destination provided by the second user 710.

In some scenarios, if a user (e.g., the first user 702, the second user 710, etc.) has stored a location in his/her mobile device and wants to start a navigation/direction to that location via an infotainment system (e.g., the infotainment system 708), the user may be specified to unpair an old device (e.g., a previous infotainment system connected by the user) and pair his/her mobile device to the new/current infotainment system. In some implementations, to pair a new device (e.g., the first mobile device 704, the second mobile device 712, etc.) to an infotainment system (e.g., the infotainment system 708), such as for the first time, the car (e.g., the car 706) may be specified/configured to stop first for the infotainment system to detect the new device and pair with the new device.

As described in connection with FIGS. 6 and 7, when a user searches/enters a destination on a mobile device and starts navigation/directions on the mobile device, and then enters a car with an infotainment system, the user may be specified to enter/start the navigation manually (e.g., re-enter the destination) in the infotainment system to start the navigation/directions via the infotainment system. Also, when a group of users are travelling in the same car, an infotainment system of the car may be paired with one mobile device (initially). Later when one or more users want to set a destination to a saved place from their mobile devices, they may be specified to pair their mobile devices to the infotainment system and/or search/enter their destinations manually (e.g., via the screen of the infotainment system). In some scenarios, all of these actions may cause distractions to the driver of the car. In some scenarios, the car may be configured/specified to stop for the infotainment system to start scanning (e.g., performing Bluetooth® low energy (BLE) scanning) for new device(s).

Aspects presented herein may improve the efficiency of navigation by enabling a navigation system/application to be paired with one or more user equipments (UEs) (e.g., mobile phones, smart watches, etc.) and to resume/continue navigation session(s) performed by the one or more UEs via the navigation system/application automatically. Aspects presented herein may enable automatic detection of devices and sharing contexts between devices based on using a context sharing framework (which may also be referred to as a data sharing protocol), such as using a distributed context fabriq (DCF) framework, where such context sharing framework may enable devices to be configured to perform/act intelligently without much user input(s). For example, a seamless navigation and transition experience may be provided between a mobile device and a car infotainment system, which may reduce distractions to drivers during driving.

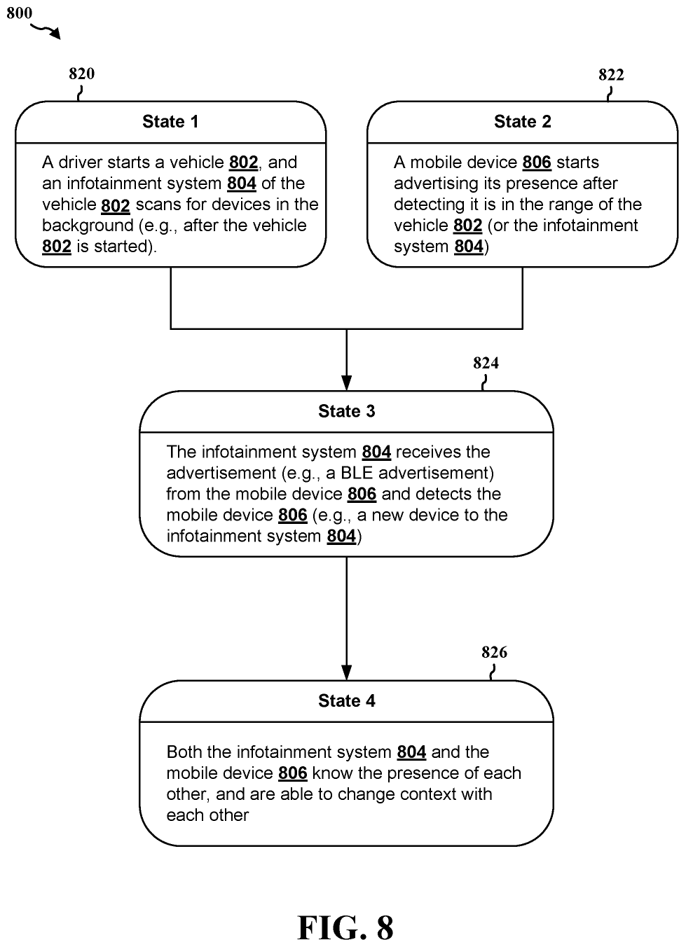

FIG. 8 is a diagram 800 illustrating an example of a context sharing framework in accordance with various aspects of the present disclosure. In one aspect of the present disclosure, a context sharing framework (which may also be referred to as a “data sharing protocol”) may be configured between multiple devices to enable the devices to discover each other and share/exchange context (e.g., information, data, etc.) with each other. For example, aspects presented herein may be based on a DCF feature, where communication between a mobile device and an infotainment system may be configured to be seamless due to auto discovery of device(s)/system(s) using the DCF feature. In one example, the DCF feature may operate/work based on radio frequency (RF)/Bluetooth®/BLE extended advertising, where a device configured with the DCF feature (which may be referred to as DCF enabled devices) may have the capability to automatically detect the presence of other nearby DCF enabled devices and share contexts with them. Some examples of a context may include notifications, device-status, system information, etc.

In one example, as shown at 820, after a driver (e.g., the first user 702) starts a vehicle 802 (e.g., the car 706), an infotainment system 804 (e.g., the infotainment system 708) of the vehicle 802 may be configured to start scanning for devices in the background based on using a context sharing framework (e.g., a data sharing protocol, the DCF framework, etc.), such as by transmitting signals (e.g., dedicated DCF signals) indicating its presence and/or receiving/detecting signals (e.g., dedicated signals associated with the context sharing framework) from other devices.

As shown at 822, a mobile device 806 (e.g., the second mobile device 712, a smartphone, a smart watch, etc.) may advertise its presence using the context sharing framework (e.g., transmitting messages using message formats associated with the context sharing framework). In some examples, the mobile device 806 may be configured to advertise its presence (e.g., transmit dedicated DCF signals, Bluetooth®/BLE signals, etc.) periodically (e.g., every 10 ms, every 1 minute, etc.). In some examples, the mobile device 806 may be configured to advertise its presence based on a triggering condition, such as after detecting it is in the range of the vehicle 802 (or the infotainment system 804) (e.g., after receiving the dedicated DCF signals from the infotainment system 804). For purposes of the present disclosure, it may be assumed that both the infotainment system 804 the mobile device 806 are using the same context sharing framework (e.g., both are DCF enabled devices) or using different context sharing frameworks that are compatible with each other.

As shown at 824, after the infotainment system 804 receives the advertisement (e.g., the Bluetooth®/BLE advertisement), the infotainment system 804 may detect (or become aware of) the mobile device 806, which may be a new device to the infotainment system 804 (e.g., meaning they may not have been paired before).

As shown at 826, after both the infotainment system 804 and the mobile device 806 know (e.g., become aware of) the presence of each other, they may be able to start change/exchange/share context with each other, such as by exchanging or sharing navigation information, device status, and/or user information with each other. Aspects described in connection with FIG. 8 provide an example sequence of events between an infotainment system and a mobile device to detect the presence of each other.

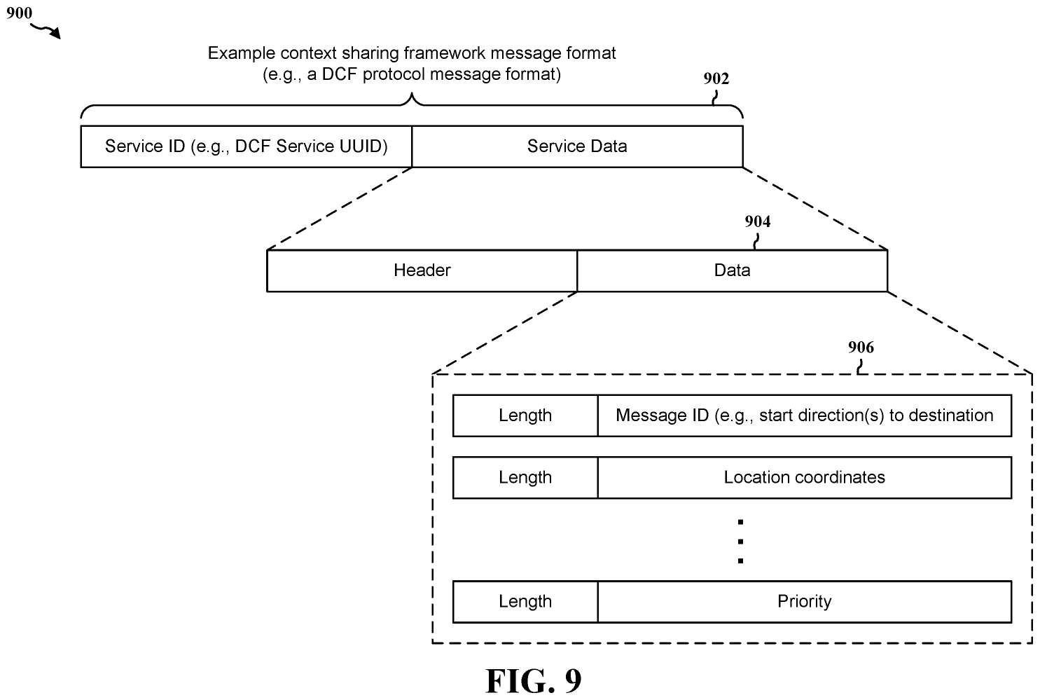

FIG. 9 is a diagram 900 illustrating an example of a context sharing framework message format in accordance with various aspects of the present disclosure. As shown at 902, an example context sharing framework message (or message format) that may be used by a device (e.g., the infotainment system 804, the mobile device 806, etc.) for advertising its presence may include a service ID section (e.g., a DCF service universally unique identifier (UUID)) and a service data section. As shown at 904, the service data section may further include a header and its corresponding data section, where the corresponding data section may include information/data to be advertised by the device as shown at 906. After a receiving device (e.g., after the infotainment system 804 receives this message from the mobile device 806 and/or vice versa), the receiving device may be configured to decode the message (in the same) order using the protocol dedicated to the context sharing framework (e.g., using the DCF protocol).

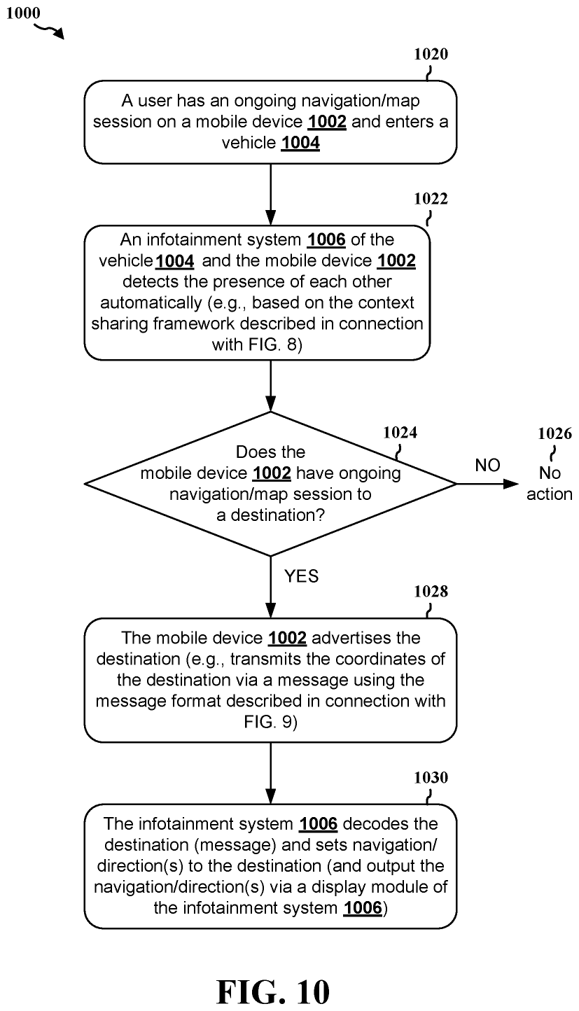

FIG. 10 is a diagram 1000 illustrating an example of using a context sharing framework to continue an ongoing navigation/map session in one device on another device in accordance with various aspects of the present disclosure. Aspects presented herein may provide a use case scenario where a user using a mobile device for navigation may resume the navigation via an infotainment system of a vehicle (or pass the navigation information to the infotainment system for the driver of the vehicle to view/utilize the navigation) after the user enters the car.

As shown at 1020, a user (e.g., the user 602) may be using a navigation application on the user's mobile device 1002 (e.g., the mobile device 604) for reaching a destination (e.g., the destination 606), where the navigation application may calculate and output a recommended travelling route (e.g., a shortest route, a fastest route, etc.) for the user based on the destination, such as described in connection with FIG. 5. This navigation process may be referred to as an “ongoing navigation session” or “an ongoing map session” for purposes of the present disclosure. Then, while the user is performing the ongoing navigation/map session on the mobile device 1002, the user may enter a vehicle 1004 (e.g., the car 608) that has an infotainment system 1006.

As shown at 1022, after the user enters the vehicle 1004, the infotainment system 1006 and the mobile device 1002 may detect the presence of each other automatically (e.g., based on using the context sharing framework/data sharing protocol described in connection with FIG. 8). For example, the infotainment system 1006 may scan for new devices in the background and the mobile device 1002 may advertise its presence. After the infotainment system 1006 receives the advertisement from the mobile device 1002, both the infotainment system 1006 and the mobile device 1002 may become aware of the presence of each other, and may be able to exchange various context/information with each other.

As shown at 1024, the mobile device 1002 and/or the infotainment system 1006 may determine whether there is an ongoing navigation/map session to a destination. As shown at 1026, if the mobile device 1002 does not have an ongoing navigation/map session, then the mobile device 1002 and/or the infotainment system 1006 may not perform any actions.

On the other hand, as shown at 1028, if the mobile device 1002 has an ongoing navigation/map session to a destination, the mobile device 1002 may advertise the destination, such as by transmitting, broadcasting, or unicasting the coordinates of the destination via a message (e.g., using the context sharing framework message format described in connection with FIG. 9).

As shown at 1030, after receiving the destination (e.g., the message containing the destination), the infotainment system 1006 may decode the destination (message) and sets navigation/map to the destination on the infotainment system 1006. In other words, the infotainment system 1006 may resume/continue the ongoing navigation/map session to the destination, such as by outputting the navigation/map/direction(s) via a display module (e.g., a screen) of the infotainment system 1006 (e.g., as described in connection with FIG. 5). In some examples, after the mobile device 1002 advertises its destination and/or after the infotainment system 1006 resumes/continues the ongoing navigation/map session, the infotainment system 1006 may transmit an indication to the mobile device 1002 confirming the processing/resuming of the navigation/map session (or a confirmation of route information). In some examples, after the mobile device 1002 advertises its destination and/or after the infotainment system 1006 resumes/continues the ongoing navigation/map session, the mobile device 1002 may terminate or hold the on navigation/map session on the mobile device 1002 (which may be based on receiving a navigation confirmation from the infotainment system 1006), such as for power saving purposes. In other examples, after the mobile device 1002 advertises its destination and/or after the infotainment system 1006 resumes/continues the ongoing navigation/map session, the mobile device 1002 may also continue the navigation/map session on the mobile device 1002. In some examples, if the connection between the mobile device 1002 and the infotainment system 1006 is connected or lost, the mobile device 1002 may be configured to automatically resume the navigation/map session, such as calculating a route for the destination based on the current location of the mobile device 1002. In some examples, the mobile device 1002 and the infotainment system 1006 are communicating with each other based on the context sharing framework without a central server involved (e.g., without exchanging messages via a central server).

Aspects described in connection with FIG. 10 may enable both the mobile device 1002 and the infotainment system 1006 to detect each other and form an ecosystem (e.g., such as using the presence detection framework discussed in connection with FIG. 8). After the detection, the mobile device may use the protocol provided by the framework (e.g., using a DCF protocol, such as a BLE DCF service UUID) to advertise the location coordinates of the destination. The infotainment system 1006, which is scanning in the background, may receive the advertisement (e.g., a BLE advertisement) and decode the message. Once the infotainment system (e.g., the DCF service running in the infotainment system) reads/decodes the location coordinates, the infotainment system may direct the navigation/map application to start/resume navigations/directions to the destination on the screen of the infotainment system. For purposes of the present disclosure, an ecosystem may refer to a group of devices that are able to exchange/share data or information (e.g., collectively as “context”) with each other.

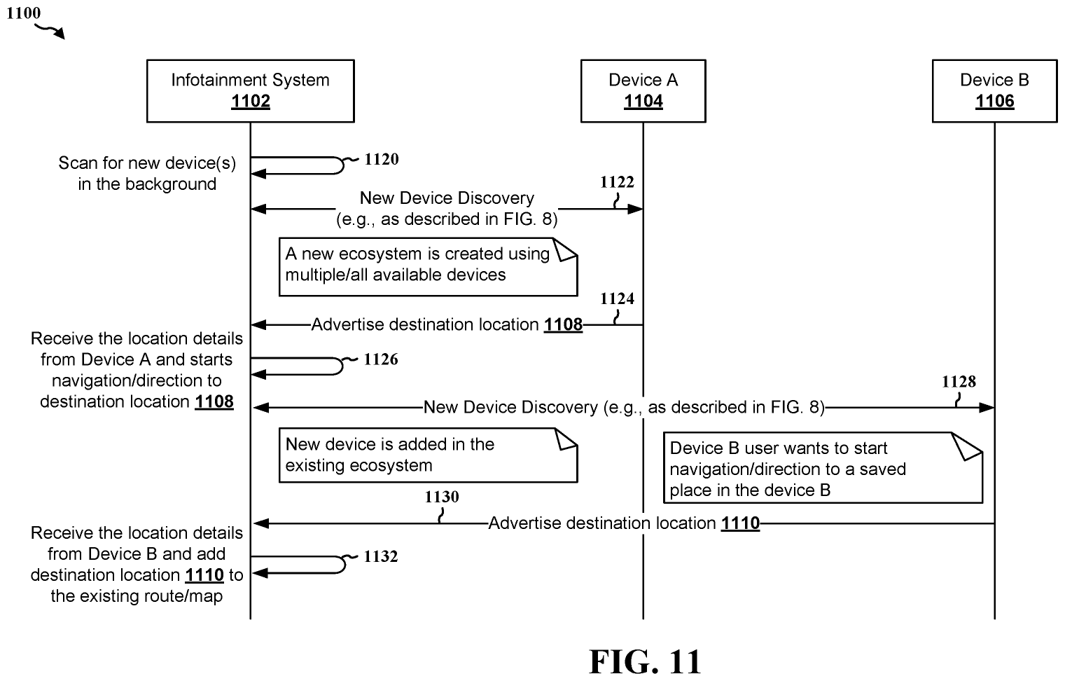

FIG. 11 is a diagram 1100 illustrating an example of using a context sharing framework to continue ongoing navigation/map sessions in multipole devices on another device in accordance with various aspects of the present disclosure. Aspects presented herein may provide a use case scenario where multiple users using mobile devices for navigation may resume their navigation via an infotainment system of a vehicle (or pass the navigation information to the infotainment system for the driver of the vehicle to view the navigation) after the users enter the vehicle (multiple people are travelling in same vehicle).

At 1120, an infotainment system 1102 (e.g., the infotainment system 708) of a vehicle (e.g., the car 706) may be configured to perform a background scan for new devices (based on using a context sharing framework such as a DCF framework), such as described in connection with FIG. 8. For example, the infotainment system 1102 may broadcast its presence by transmitting dedicated broadcast message(s)/signal(s), and/or receiving/detecting dedicated message(s)/signal(s).

At 1122, a first mobile device 1104 (used by a first user such the first user 702) may start advertising its presence after detecting it is in the range of the infotainment system 1102. After the first mobile device 1104 and the infotainment system 1102 detect the presence of each other (e.g., become aware of each other), the first mobile device 1104 and the infotainment system 1102 (any other additional devices in the range of the infotainment system 1102) may form an ecosystem (e.g., based on the context sharing framework). In other words, all/multiple devices in the vehicle and the infotainment system 1102 may detect the presence of each other and automatically use the context sharing framework to form an ecosystem.

At 1124, if the user of the first mobile device 1104 wants to start a navigation/map session on the infotainment system 1102 to a destination location 1108, which may be already saved in the first mobile device 1104, the first mobile device 1104 may be configured to advertise the destination location 1108 (e.g., the location coordinates of the destination location 1108), such as to the infotainment system 1102. In some examples, such advertisement message (if it is a broadcast message) may also be received by other devices (e.g., mobile devices of other users) in the vehicle. In addition, the first mobile device 1104 may transmit/broadcast the advertisement message using a protocol dedicated to (configured for) the context sharing framework, such as described in connection with FIG. 9. In some examples, the advertisement message may be transmitted via using Bluetooth®/BLE advertising messaging.

At 1126, after the infotainment system 1102 receives the advertisement message transmitted from the first mobile device 1104 that includes the destination location 1108, the infotainment system 1102 may decode and process the advertisement message, and the infotainment system 1102 may start the navigation/direction to the destination location 1108 (if there is no ongoing navigation/direction session to the destination location 1108 on the first mobile device 1104), or resume/continue the navigation/direction to the destination location 1108 (if there is an ongoing navigation/direction session to the destination location 1108 on the first mobile device 1104), such as described in connection with FIG. 10. For example, the infotainment system 1102 may direct a navigation/map application to start/resume navigation/directions to the destination location 1108 on a display screen, such as described in connection with FIG. 5.

At 1128, a second mobile device 1106 (used by a second user such the second user 710) may start advertising its presence after detecting it is in the range of the infotainment system 1102 (e.g., after the user of the second mobile device 1106 enters the vehicle). After the second mobile device 1106 and the infotainment system 1102 detect the presence of each other (e.g., become aware of each other), the second mobile device 1106 may join the existing ecosystem formed by the infotainment system 1102 and the first mobile device 1104 (and also other devices that have already joined the ecosystem previously), such that the second mobile device 1106 may share context/information with the infotainment system 1102 and/or the first mobile device 1104 based on the context sharing framework.

At 1130, if the user of the second mobile device 1106 wants to start/resume a navigation/map session on the infotainment system 1102 to a destination location 1110, which may also be already saved in the second mobile device 1106, the second mobile device 1106 may be configured to advertise the destination location 1110 (e.g., the location coordinates of the destination location 1110), such as to the infotainment system 1102 (and may also be received by the first mobile device 1104 if it is a broadcast message). Similarly, the second mobile device 1106 may transmit/broadcast the advertisement message using the protocol dedicated to (configured for) the context sharing framework, such as described in connection with FIG. 9.

At 1132, after the infotainment system 1102 receives the advertisement message transmitted from the second mobile device 1106 that includes the destination location 1110, the infotainment system 1102 may decode and process the advertisement message. As the user of the first mobile device 1104 already sets the destination location 1108 on the infotainment system 1102 (e.g., via the display screen) and if the user of the second mobile device 1106 also wants to set the destination location 1110 on the infotainment system 1102, the infotainment system 1102 may be configured to apply at least one prioritization algorithm to resolve conflicts. For example, after the infotainment system 1102 receives the destination location 1110 from the second mobile device 1106, the infotainment system 1102 may invoke a navigation/maps application to add the infotainment system 1102 to the existing travelling route (e.g., the destination points list for the navigation/map session may be updated as [Destination Location 1108, Destination Location 1110]). In addition, the infotainment system 1102 may update the notifications on the display screen when destination is being added and/or changed.

In some examples, the prioritization of destinations may be based on their distances. For example, if the destination location 1110 is closer to the present location of the vehicle compared to the destination location 1108, the infotainment system 1102 may navigate/direct the driver of the vehicle (via the display screen) to go to the destination location 1110 first. In some examples, providing an optimized route for all destination-points (e.g., for both the destination location 1108 and the destination location 1110) may be in the context of the navigation/map application being used (e.g., determined by the algorithm(s) of the navigation/map application). As such, aspects presented herein may enable multiple users to enter a vehicle and resume their navigation/map sessions via the infotainment system of the vehicle without inputting (manually) their destination again on the infotainment system.

Aspects presented herein are directed to techniques/protocols for enhancing map context exchange/sharing between UEs and car infotainment system. Aspects presented herein include following aspects based on DCF (distributed context fabriq) feature/protocol: 1) Scenario 1: where a user has an ongoing maps session in mobile/wearable device: DCF-based discovery and context sharing between a mobile device and car infotainment system to manage maps/navigation system based on map context information (e.g., location coordinates of destination) provided by the mobile device to the infotainment system using DCF. 2) Multiple people are travelling in same vehicle: DCF-based discovery and context sharing between multiple devices in the car and the infotainment system to manage maps/navigation systems including conflict resolution when multiple people want to set different destinations in maps/navigation.

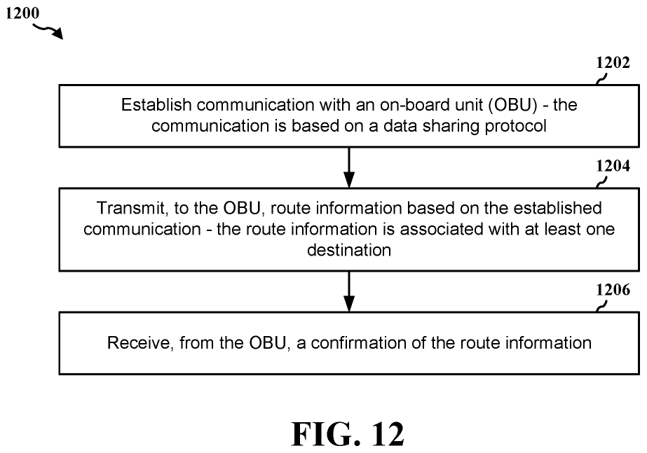

FIG. 12 is a flowchart 1200 of a method of wireless communication. The method may be performed by a UE (e.g., the UE 104, 404; the mobile device 604, 806, 1002; the first mobile device 704, 1104; the second mobile device 712, 1106; the apparatus 1304). The method may enable the UE to transmit/broadcast navigation information associated with a navigation session to another UE (referring to as an on-board unit (OBU) for purposes of the disclosure and differentiation) to enable another UE to resume/continue the navigation session.

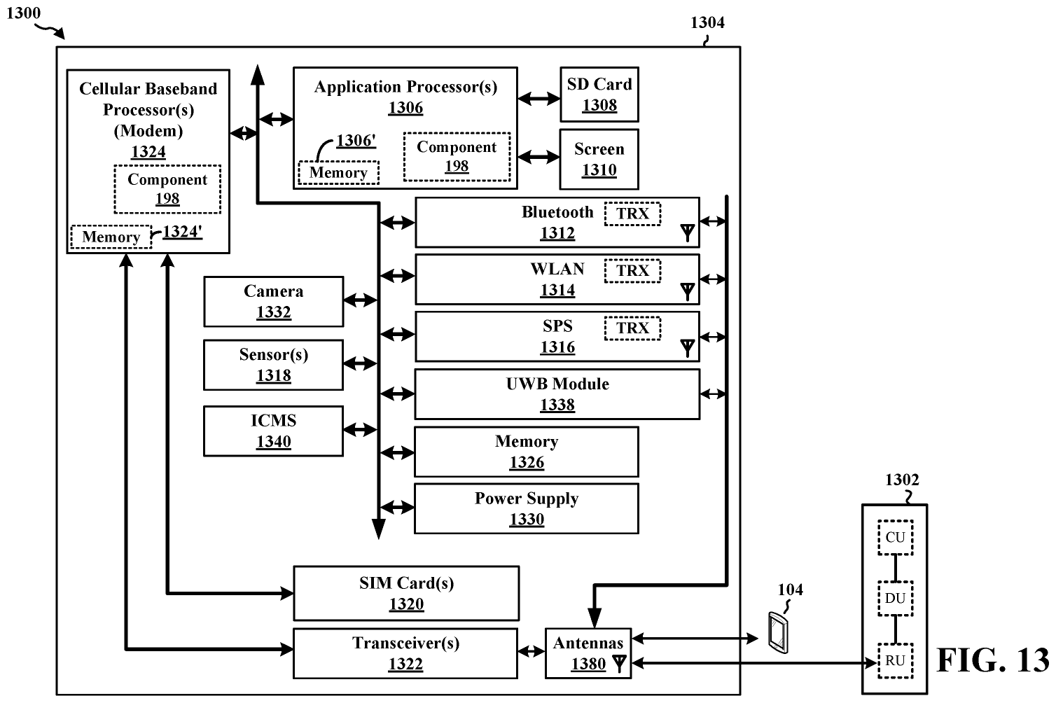

At 1202, the UE may establish communication with an on-board unit (OBU), where the communication is based on a data sharing protocol, such as described in connection with FIGS. 8 to 11. For example, as discussed in connection with 1022 of FIG. 10, the mobile device 1002 and the infotainment system 1006 may detect the presence of each other automatically (e.g., based on the context sharing framework described in connection with FIG. 8), and share context/information with other. The establishment of the communication may be performed by, e.g., the context sharing framework component 198, the transceiver(s) 1322, the cellular baseband processor(s) 1324, and/or the application processor(s) 1306 of the apparatus 1304 in FIG. 13.

At 1204, the UE may transmit, to the OBU, route information based on the established communication, where the route information may be associated with at least one destination, such as described in connection with FIGS. 8 to 11. For example, as discussed in connection with 1028 of FIG. 10, the mobile device 1002 may advertise a destination (e.g., transmit the coordinates of the destination via a message using the message format described in connection with FIG. 9). The transmission of the route information may be performed by, e.g., the context sharing framework component 198, the transceiver(s) 1322, the cellular baseband processor(s) 1324, and/or the application processor(s) 1306 of the apparatus 1304 in FIG. 13.

At 1206, the UE may receive, from the OBU, a confirmation of the route information, such as described in connection with FIGS. 8 to 11. For example, as discussed in connection with FIG. 10, after the mobile device 1002 advertises its destination and/or after the infotainment system 1006 resumes/continues the ongoing navigation/map session, the infotainment system 1006 may transmit an indication to the mobile device 1002 confirming the processing/resuming of the navigation/map session (or a confirmation of route information). The reception of the confirmation may be performed by, e.g., the context sharing framework component 198, the transceiver(s) 1322, the cellular baseband processor(s) 1324, and/or the application processor(s) 1306 of the apparatus 1304 in FIG. 13.

In one example, the OBU may be associated with an infotainment system.

In another example, to establish the communication with the OBU, the UE may obtain an indication that the UE is within a communication range of the OBU, and advertise a presence of the UE based on the indication.

In another example, the data sharing protocol may be a distributed context sharing platform, and to transmit the route information, the UE may transmit the route information via at least one message associated with the distributed context sharing platform. In some implementations, the at least one message associated with the distributed context sharing platform may be one of: at least one broadcast message; or at least one unicast message.

In another example, the UE may receive an input to the at least one destination, calculate a route for the at least one destination based on the input, and output the calculated route via a display module of the UE. In some implementations, the UE may terminate or delay the output of the calculated route via the display module based on the reception of the confirmation.

In another example, the UE may receive, from the OBU, second route information based on the route information and a destination of a second UE.

In another example, the UE may detect that the communication with the OBU is unavailable for termination, and calculate a route for the at least one destination based on a current location of the UE.

In another example, the data sharing protocol may not be associated with a central server.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an ultrawide band (UWB) module 1338, an in-cabin monitoring system (ICMS) 1340, an SPS module 1316 (e.g., GNSS module), one or more sensors 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the UWB module 1338, the ICMS 1340, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the context sharing framework component 198 may be configured to establish communication with an OBU, where the communication is based on a data sharing protocol. The context sharing framework component 198 may also be configured to transmit, to the OBU, route information based on the established communication, where the route information is associated with at least one destination. The context sharing framework component 198 may also be configured to receive, from the OBU, a confirmation of the route information. The context sharing framework component 198 may be within the cellular baseband processor(s) 1324, the application processor(s) 1306, or both the cellular baseband processor(s) 1324 and the application processor(s) 1306. The context sharing framework component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for establishing communication with an OBU, where the communication is based on a data sharing protocol. The apparatus 1304 may further include means for transmitting, to the OBU, route information based on the established communication, where the route information is associated with at least one destination. The apparatus 1304 may further include means for receiving, from the OBU, a confirmation of the route information.

In one configuration, the OBU may be associated with an infotainment system.

In another configuration, the means for establishing the communication with the OBU may include configuring the apparatus 1304 to obtain an indication that the UE is within a communication range of the OBU, and advertise a presence of the UE based on the indication.

In another configuration, the data sharing protocol may be a distributed context sharing platform, and the means for transmitting the route information may include configuring the apparatus 1304 to transmit the route information via at least one message associated with the distributed context sharing platform. In some implementations, the at least one message associated with the distributed context sharing platform may be one of: at least one broadcast message; or at least one unicast message.

In another configuration, the apparatus 1304 may further include means for receiving an input to the at least one destination, means for calculating a route for the at least one destination based on the input, and means for outputting the calculated route via a display module of the UE. In some implementations, the apparatus 1304 may further include means for terminating or delaying the output of the calculated route via the display module based on the reception of the confirmation.

In another configuration, the apparatus 1304 may further include means for receiving, from the OBU, second route information based on the route information and a destination of a second UE.

In another configuration, the apparatus 1304 may further include means for detecting that the communication with the OBU is unavailable for termination, and means for calculating a route for the at least one destination based on a current location of the UE.

In another configuration, the data sharing protocol may not be associated with a central server.

The means may be the context sharing framework component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

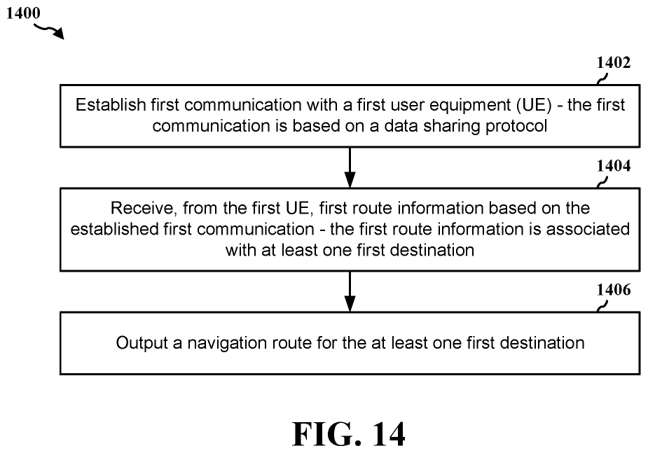

FIG. 14 is a flowchart 1400 of a method of wireless communication. The method may be performed by an OBU (e.g., the UE 104, 404; the infotainment system 708, 804, 1006, 1102; the apparatus 1504). The method may enable the OBU to resume/continue navigation session(s) performed by one or more UE(s).

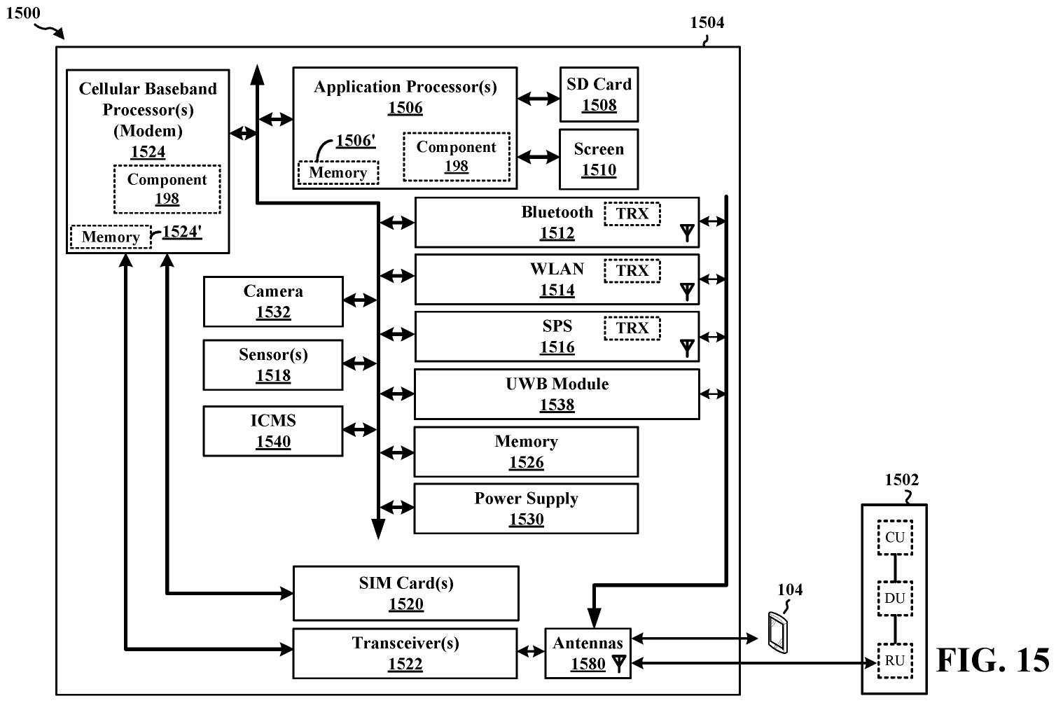

At 1402, the OBU may establish first communication with a first UE, where the first communication is based on a data sharing protocol, such as described in connection with FIGS. 8 to 11. For example, as discussed in connection with 1022 of FIG. 10, the mobile device 1002 and the infotainment system 1006 may detect the presence of each other automatically (e.g., based on the context sharing framework described in connection with FIG. 8), and share context/information with other. The establishment of the first communication may be performed by, e.g., the context sharing framework component 198, the transceiver(s) 1522, the cellular baseband processor(s) 1524, and/or the application processor(s) 1506 of the apparatus 1504 in FIG. 15.

At 1404, the UE may receive, from the first UE, first route information based on the established first communication, where the first route information is associated with at least one first destination, such as described in connection with FIGS. 8 to 11. For example, as discussed in connection with 1028 of FIG. 10, the infotainment system 1006 may receive a destination advertisement from the mobile device 1002 (e.g., receive the coordinates of the destination via a broadcast/unicast message). The reception of the first route information may be performed by, e.g., the context sharing framework component 198, the transceiver(s) 1322, the cellular baseband processor(s) 1324, and/or the application processor(s) 1306 of the apparatus 1304 in FIG. 13.

At 1406, the OBU may output a navigation route for the at least one first destination, such as described in connection with FIGS. 8 to 11. For example, as discussed in connection with 1030 of FIG. 10, the infotainment system 1006 may decode the destination (message) and sets navigation/direction(s) to the destination (and output the navigation/direction(s) via a display module of the infotainment system 1006). The output of the navigation route may be performed by, e.g., the context sharing framework component 198, the transceiver(s) 1522, the cellular baseband processor(s) 1524, and/or the application processor(s) 1506 of the apparatus 1504 in FIG. 15.

In one example, the OBU may establish second communication with at least a second UE, receive, from the second UE, second route information based on the established second communication, where the second route information is associated with at least one second destination, and prioritize one of the at least one first destination or the least one second destination. In some implementations, to output the navigation route for the at least one first destination, the OBU may output the navigation route for the at least one first destination or the at least one second destination based on the prioritization.

In another example, the OBU may transmit, to the first UE, a first confirmation of the reception of the first route information.

In another example, to output the navigation route for the at least one first destination, the OBU may display, on a display device, the navigation route for the at least one first destination.

In another example, the OBU may be associated with an infotainment system.

In another example, to establish the first communication with the first UE, the OBU may receive an indication that the first UE is within a communication range of the OBU, and exchange information with the first UE based on the indication.

In another example, the data sharing protocol may be a distributed context sharing platform, and to receive the first route information, the OBU may receive the first route information via at least one message associated with the distributed context sharing platform. In some implementations, the at least one message associated with the distributed context sharing platform is one of: at least one broadcast message; or at least one unicast message.

In another example, the data sharing protocol may not be associated with a central server.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an ultrawide band (UWB) module 1538, an in-cabin monitoring system (ICMS) 1540, an SPS module 1516 (e.g., GNSS module), one or more sensors 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the UWB module 1538, the ICMS 1540, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the context sharing framework component 198 may be configured to establish first communication with a first UE, where the first communication is based on a data sharing protocol. The context sharing framework component 198 may also be configured to receive, from the first UE, first route information based on the established first communication, where the first route information is associated with at least one first destination. The context sharing framework component 198 may also be configured to output a navigation route for the at least one first destination. The context sharing framework component 198 may be within the cellular baseband processor(s) 1524, the application processor(s) 1506, or both the cellular baseband processor(s) 1524 and the application processor(s) 1506. The context sharing framework component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for establishing first communication with a first UE, where the first communication is based on a data sharing protocol. The apparatus 1504 may further include means for receiving, from the first UE, first route information based on the established first communication, where the first route information is associated with at least one first destination. The apparatus 1504 may further include means for outputting a navigation route for the at least one first destination.

In one configuration, the apparatus 1504 may further include means for establishing second communication with at least a second UE, means for receiving, from the second UE, second route information based on the established second communication, where the second route information is associated with at least one second destination, and means for prioritizing one of the at least one first destination or the least one second destination. In some implementations, the means for outputting the navigation route for the at least one first destination may include configuring the apparatus 1504 to output the navigation route for the at least one first destination or the at least one second destination based on the prioritization.

In another configuration, the apparatus 1504 may further include means for transmitting, to the first UE, a first confirmation of the reception of the first route information.

In another configuration, the means for outputting the navigation route for the at least one first destination may include configuring the apparatus 1504 to display, on a display device, the navigation route for the at least one first destination.

In another configuration, the OBU may be associated with an infotainment system.

In another configuration, the means for establishing the first communication with the first UE may include configuring the apparatus 1504 to receive an indication that the first UE is within a communication range of the OBU, and exchange information with the first UE based on the indication.

In another configuration, the data sharing protocol may be a distributed context sharing platform, and the means for receiving the first route information may include configuring the apparatus 1504 to receive the first route information via at least one message associated with the distributed context sharing platform. In some implementations, the at least one message associated with the distributed context sharing platform is one of: at least one broadcast message; or at least one unicast message.

In another configuration, the data sharing protocol may not be associated with a central server.

The means may be the context sharing framework component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, Conly, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: establishing communication with an on-board unit (OBU), wherein the communication is based on a data sharing protocol; transmitting, to the OBU, route information based on the established communication, wherein the route information is associated with at least one destination; and receiving, from the OBU, a confirmation of the route information.

Aspect 2 is the method of aspect 1, wherein the OBU is associated with an infotainment system.

Aspect 3 is the method of aspect 1 or aspect 2, wherein establishing the communication with the OBU comprises: obtaining an indication that the UE is within a communication range of the OBU; and advertising a presence of the UE based on the indication.

Aspect 4 is the method of any of aspects 1 to 3, wherein the data sharing protocol is a distributed context sharing platform, and wherein transmitting the route information comprises transmitting the route information via at least one message associated with the distributed context sharing platform.

Aspect 5 is the method of any of aspects 1 to 4, wherein the at least one message associated with the distributed context sharing platform is one of: at least one broadcast message; or at least one unicast message.

Aspect 6 is the method of any of aspects 1 to 5, further comprising: receiving an input to the at least one destination; calculating a route for the at least one destination based on the input; and outputting the calculated route via a display module of the UE.

Aspect 7 is the method of any of aspects 1 to 6, further comprising: terminating or delaying the output of the calculated route via the display module based on the reception of the confirmation.

Aspect 8 is the method of any of aspects 1 to 7, further comprising: receiving, from the OBU, second route information based on the route information and a destination of a second UE.

Aspect 9 is the method of any of aspects 1 to 8, further comprising: detecting that the communication with the OBU is unavailable for termination; and calculating a route for the at least one destination based on a current location of the UE.

Aspect 10 is the method of any of aspects 1 to 9, wherein the data sharing protocol is not associated with a central server.

Aspect 11 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 10.

Aspect 12 is the apparatus of aspect 11, further including at least one of a transceiver or an antenna coupled to the at least one processor.

Aspect 13 is an apparatus for wireless communication including means for implementing any of aspects 1 to 10.

Aspect 14 is a computer-readable medium (e.g., a non-transitory computer-readable medium) storing computer executable code, where the code when executed by a processor causes the processor to implement any of aspects 1 to 10.

Aspect 15 is a method of wireless communication at an on-board unit (OBU), comprising: establishing first communication with a first user equipment (UE), wherein the first communication is based on a data sharing protocol; receiving, from the first UE, first route information based on the established first communication, wherein the first route information is associated with at least one first destination; and outputting a navigation route for the at least one first destination.

Aspect 16 is the method of aspect 15, further comprising: establishing second communication with at least a second UE; receiving, from the second UE, second route information based on the established second communication, wherein the second route information is associated with at least one second destination; and prioritizing one of the at least one first destination or the least one second destination.

Aspect 17 is the method of aspect 15 or aspect 16, wherein outputting the navigation route for the at least one first destination comprises: outputting the navigation route for the at least one first destination or the at least one second destination based on the prioritization.

Aspect 18 is the method of any of aspects 15 to 17, further comprising: transmitting, to the first UE, a first confirmation of the reception of the first route information.

Aspect 19 is the method of any of aspects 15 to 18, wherein outputting the navigation route for the at least one first destination comprises: displaying, on a display device, the navigation route for the at least one first destination.

Aspect 20 is the method of any of aspects 15 to 19, wherein the OBU is associated with an infotainment system.

Aspect 21 is the method of any of aspects 15 to 20, wherein establishing the first communication with the first UE comprises: receiving an indication that the first UE is within a communication range of the OBU; and exchanging information with the first UE based on the indication.

Aspect 22 is the method of any of aspects 15 to 21, wherein the data sharing protocol is a distributed context sharing platform, and wherein receiving the first route information comprises receiving the first route information via at least one message associated with the distributed context sharing platform.

Aspect 23 is the method of any of aspects 15 to 22, wherein the at least one message associated with the distributed context sharing platform is one of: at least one broadcast message; or at least one unicast message.

Aspect 24 is the method of any of aspects 15 to 23, wherein the data sharing protocol is not associated with a central server.

Aspect 25 is an apparatus for wireless communication at an on-board unit (OBU), including: at least one memory; and at least one processor coupled to the at least one memory and, based at least in part on information stored in the at least one memory, the at least one processor, individually or in any combination, is configured to implement any of aspects 15 to 24.

Aspect 26 is the apparatus of aspect 25, further including at least one of a transceiver or an antenna coupled to the at least one processor.

Aspect 27 is an apparatus for wireless communication including means for implementing any of aspects 15 to 24.

Aspect 28 is a computer-readable medium (e.g., a non-transitory computer-readable medium) storing computer executable code, where the code when executed by a processor causes the processor to implement any of aspects 15 to 24.

What is claimed is:

1. An apparatus for wireless communication at a user equipment (UE), comprising:
at least one memory; and
at least one processor coupled to the at least one memory, the at least one processor, individually or in any combination, is configured to:
establish communication with an on-board unit (OBU), wherein the communication is based on a data sharing protocol;
transmit, to the OBU, route information based on the established communication, wherein the route information is associated with at least one destination; and
receive, from the OBU, a confirmation of the route information.

2. The apparatus of claim 1, wherein the OBU is associated with an infotainment system.

3. The apparatus of claim 1, wherein to establish the communication with the OBU, the at least one processor, individually or in any combination, is configured to:
obtain an indication that the UE is within a communication range of the OBU; and
advertise a presence of the UE based on the indication.

4. The apparatus of claim 1, wherein the data sharing protocol is a distributed context sharing platform, and wherein to transmit the route information, the at least one processor, individually or in any combination, is configured to transmit the route information via at least one message associated with the distributed context sharing platform.

5. The apparatus of claim 4, wherein the at least one message associated with the distributed context sharing platform is one of:
at least one broadcast message; or
at least one unicast message.

6. The apparatus of claim 1, wherein the at least one processor, individually or in any combination, is further configured to:
receive an input to the at least one destination;
calculate a route for the at least one destination based on the input; and
output the calculated route via a display module of the UE.

7. The apparatus of claim 6, wherein the at least one processor, individually or in any combination, is further configured to:
terminate or delay the output of the calculated route via the display module based on the reception of the confirmation.

8. The apparatus of claim 1, wherein the at least one processor, individually or in any combination, is further configured to:
receive, from the OBU, second route information based on the route information and a destination of a second UE.

9. The apparatus of claim 1, wherein the at least one processor, individually or in any combination, is further configured to:
detect that the communication with the OBU is unavailable for termination; and
calculate a route for the at least one destination based on a current location of the UE.

10. The apparatus of claim 1, wherein the data sharing protocol is not associated with a central server.

11. The apparatus of claim 1, further comprising at least one of a transceiver or an antenna coupled to the at least one processor, wherein to transmit the route information, the at least one processor, individually or in any combination, is configured to transmit the route information via at least one of the transceiver or the antenna.

12. A method of wireless communication at a user equipment (UE), comprising:
establishing communication with an on-board unit (OBU), wherein the communication is based on a data sharing protocol;
transmitting, to the OBU, route information based on the established communication, wherein the route information is associated with at least one destination; and
receiving, from the OBU, a confirmation of the route information.

13. The method of claim 12, wherein establishing the communication with the OBU comprises:
obtaining an indication that the UE is within a communication range of the OBU; and
advertising a presence of the UE based on the indication.

14. The method of claim 12, further comprising:
receiving an input to the at least one destination;
calculating a route for the at least one destination based on the input; and
outputting the calculated route via a display module of the UE.

15. The method of claim 12, further comprising:
receiving, from the OBU, second route information based on the route information and a destination of a second UE.

16. An apparatus for wireless communication at an on-board unit (OBU), comprising:
at least one memory; and
at least one processor coupled to the at least one memory, the at least one processor, individually or in any combination, is configured to:
establish first communication with a first user equipment (UE), wherein the first communication is based on a data sharing protocol;
receive, from the first UE, first route information based on the established first communication, wherein the first route information is associated with at least one first destination; and
output a navigation route for the at least one first destination.

17. The apparatus of claim 16, wherein the at least one processor, individually or in any combination, is further configured to:
establish second communication with at least a second UE;
receive, from the second UE, second route information based on the established second communication, wherein the second route information is associated with at least one second destination; and
prioritize one of the at least one first destination or the least one second destination.

18. The apparatus of claim 17, wherein to output the navigation route for the at least one first destination, the at least one processor, individually or in any combination, is configured to:
output the navigation route for the at least one first destination or the at least one second destination based on the prioritization.

19. The apparatus of claim 16, wherein the at least one processor, individually or in any combination, is further configured to:
transmit, to the first UE, a first confirmation of the reception of the first route information.

20. The apparatus of claim 16, wherein to output the navigation route for the at least one first destination, the at least one processor, individually or in any combination, is configured to:
display, on a display device, the navigation route for the at least one first destination.

21. The apparatus of claim 16, wherein the OBU is associated with an infotainment system.

22. The apparatus of claim 16, wherein to establish the first communication with the first UE, the at least one processor, individually or in any combination, is configured to:
receive an indication that the first UE is within a communication range of the OBU; and
exchange information with the first UE based on the indication.

23. The apparatus of claim 16, wherein the data sharing protocol is a distributed context sharing platform, and wherein receiving the first route information comprises receiving the first route information via at least one message associated with the distributed context sharing platform.

24. The apparatus of claim 23, wherein the at least one message associated with the distributed context sharing platform is one of:
at least one broadcast message; or
at least one unicast message.

25. The apparatus of claim 16, wherein the data sharing protocol is not associated with a central server.

26. The apparatus of claim 16, further comprising at least one of a transceiver or an antenna coupled to the at least one processor, wherein to receive the first route information, the at least one processor, individually or in any combination, is configured to receive the first route information via at least one of the transceiver or the antenna.

27. A method of wireless communication at an on-board unit (OBU), comprising:
establishing first communication with a first user equipment (UE), wherein the first communication is based on a data sharing protocol;
receiving, from the first UE, first route information based on the established first communication, wherein the first route information is associated with at least one first destination; and
outputting a navigation route for the at least one first destination.

28. The method of claim 27, further comprising:
establishing second communication with at least a second UE;
receiving, from the second UE, second route information based on the established second communication, wherein the second route information is associated with at least one second destination; and
prioritizing one of the at least one first destination or the least one second destination.

29. The method of claim 27, further comprising:
transmitting, to the first UE, a first confirmation of the reception of the first route information.

30. The method of claim 27, wherein outputting the navigation route for the at least one first destination comprises:
displaying, on a display device, the navigation route for the at least one first destination.
